(19) United States
(12) Patent Application Publication
(10) Pub. No.: US 2023/0133973 A1
(43) Pub. Date: May 4, 2023

(54) NEEDLE RETAINER FOR CONSTANT VELOCITY JOINT AND METHOD OF DETERMINING TRUNNION SHAPE

(71) Applicant: Steering Solutions IP Holding Corporation, Saginaw, MI (US)

(72) Inventors: Jon N. Miller, Merrill, MI (US); Jeff P. Courville, Frankenmuth, MI (US); Eduardo Mondragon-Parra, Freeland, MI (US); Jenny C. Ho, Midland, MI (US)

(21) Appl. No.: 18/091,450

(22) Filed: Dec. 30, 2022

Related U.S. Application Data
(63) Continuation-in-part of application No. 16/752,063, filed on Jan. 24, 2020, now Pat. No. 11,585,388.
(60) Provisional application No. 62/798,787, filed on Jan. 30, 2019.

(51) Int. Cl. F16D 3/205; F16D 3/223

(52) U.S. Cl. CPC F16D 3/2055; F16D 3/223; F16D 2003/2026

(57) ABSTRACT

A constant velocity joint includes a trunnion extending radially outwardly about a trunnion axis, wherein the trunnion defines a parametric curve at an equatorial plane of the trunnion. The constant velocity joint also includes a ball surrounding the trunnion and rotatable relative thereto about a plurality of needle rollers.

### CROSS-REFERENCE TO RELATED APPLICATIONS

This application claims the benefit of priority as a continuation-in-part application to U.S. patent application Ser. No. 16/752,063, filed Jan. 24, 2020, which claims priority to U.S. Provisional Patent Application Ser. No. 62/798,787, filed on Jan. 30, 2019, the disclosures of which are each incorporated herein by reference in their entireties.

### BACKGROUND

Constant velocity joints are widely used for the transmission of rotational energy. Constant velocity joints allow a drive shaft to transmit power through a variable angle, at constant rotational speed. One type of telescoping constant velocity joint is referred to as a tripot joint. Tripot joints are particularly useful for automotive axial drive shafts, particularly in front-wheel-drive vehicles between the transaxle differential and the driving wheel, as well as other applications. These telescoping constant velocity joints transmit a torque at various rotational speeds, joint angles and telescopic positions between shaft members.

Constant velocity joints in their existing condition have the risk of fracturing roller retainers or ring retainers when subjected to high torque durability tests with excessive severity. Such a test generates cyclic loads that cause fatigue of the components.

Premium tripot joints have been designed and manufactured for several years. The interface between a trunnion and an inner ball, while very robust for strength purposes, may run into a grease starvation condition under high continuous torques. Grease starvation will lead to an increased coefficient of friction and abrasion when the inner ball slides with respect to the trunnion. Approaches like texturing (e.g., sand blasting trunnions) have been used in the past to improve lubrication, with negative side effects. For example, an increase in break-in time may result.

### SUMMARY

According to one aspect of the disclosure, a constant velocity joint includes a trunnion extending radially outwardly about a trunnion axis, wherein the trunnion defines a parametric curve at an equatorial plane of the trunnion. The constant velocity joint also includes a ball surrounding the trunnion and rotatable relative thereto about a plurality of needle rollers.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a constant velocity joint;

FIG. 2 is a perspective view of a roller retention assembly for the constant velocity joint according to one aspect of the disclosure;

FIG. 3 is an elevational view of the roller retention assembly of FIG. 2;

FIG. 4 is a perspective view of a retainer ring of the roller retention assembly of FIG. 2;

FIG. 5 is a plan view of the retainer ring;

FIG. 6 is a plan view of the retainer ring according to another aspect of the disclosure;

FIG. 7 is a view of the roller retention assembly for the constant velocity joint according to another aspect of the disclosure;

FIG. 8 is a perspective view of the roller retention assembly with Cartesian coordinates for determining a parametric trunnion shape of the assembly;

FIG. 9 is a view of polar coordinates for determining a parametric trunnion shape of the assembly;

FIG. 10 is an elevation view of the constant velocity joint;

FIGS. 11A-11C are views of a constant velocity joint having a parametric trunnion shape and illustrating a contact interface profile;

FIGS. 12A-12C are views of a constant velocity joint having a parametric trunnion shape and illustrating a contact interface profile;

FIGS. 13A-13C are views of a constant velocity joint having a parametric trunnion shape and illustrating a contact interface profile;

FIGS. 14A-14C are views of a constant velocity joint having a parametric trunnion shape and illustrating a contact interface profile; and

FIGS. 15A and 15B are views comparing different contact interface profiles.

### DETAILED DESCRIPTION

Referring now to the Figures, where the invention will be described with reference to specific embodiments, without limiting same, it is to be understood that the disclosed embodiments are merely illustrative of the present disclosure that may be embodied in various and alternative forms. Various elements of the disclosed embodiments may be combined or omitted to form further embodiments of the present disclosure. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Referring to the Figures, a constant velocity joint 10 is shown. The constant velocity joint is a telescoping constant velocity joint, which is also referred to herein as a tripot constant velocity joint, or simply a tripot joint. The tripot joint 10 is provided with a vehicle such as a truck, automobile, recreational vehicle, cargo vehicle, or the like. Such a tripot joint 10 may be suitable for use in front wheel drive vehicles and is disposed between, and operatively coupled to, a transaxle and a driving wheel or other applications where torque is transferred between two rotatable shaft members with possible axial position or angular position changes relative to each other. The tripot joint 10 transmits torque between a first shaft member 12 and a second shaft member 14. The tripot joint 10 is configured to transmit torque from the first shaft member 12 to the second shaft member 14 through various rotational speeds, joint angles, or telescopic positions.

The first shaft member 12 extends along a first axis. The second shaft member 14 extends along a second axis. The first shaft member 12 and the second shaft member 14 are configured to articulate and/or telescope relative to each other about their respective axes. The first axis and the second axis coincide or are collinear when the tripot joint 10 is at a joint angle of 0 degrees. The first axis and the second axis intersect when the tripot joint 10 is articulated or bent at an angle, i.e. when the first shaft member 12 and the second shaft member 14 are articulated relative to each other. The tripot joint 10 includes a housing 30, spider members 32, and a ball set 34.

The housing 30 is connected to the first shaft member 12 and extends along the first axis. The combination of the housing 30 and the first shaft member 12 are rotatable about the first axis. The housing 30 defines a plurality of ball set tracks or guide channels. Each guide channel extends substantially parallel to the first axis. As shown, the housing 30 defines three guide channels that are radially spaced from the first axis. Each guide channel is equally circumferentially spaced apart at 120° intervals from each other.

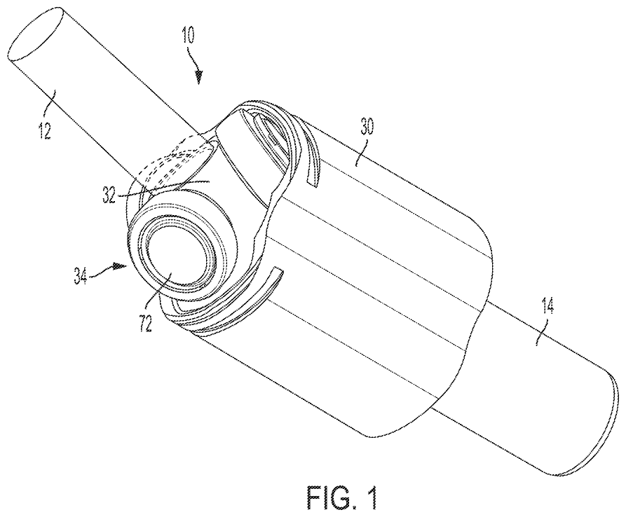

Referring now to FIGS. 1-3, each spider member 32 is configured as a trunnion 72. The trunnion 72 extends along a trunnion axis 76 away from the second axis. The trunnion axis 76 is disposed substantially perpendicular to the second axis. The trunnion 72 has a functional outer surface that transmits torque or force that is adjacent to a non-functional outer surface of the trunnion 72 that does not transmit torque or force. The ball set 34 is disposed on the functional outer surface of the trunnion 72. The trunnion 72 rotatably supports the ball set 34. As shown in the Figures, three ball assemblies are provided and disposed on respective trunnions. The ball set 34 is disposed on the trunnion 72 and is slidably or rollingly received within their respective guide channel.

The embodiments disclosed herein address the condition of fracturing roller retainers or ring retainers by consolidating two components into a single component, which has the ability to support higher cyclic loads.

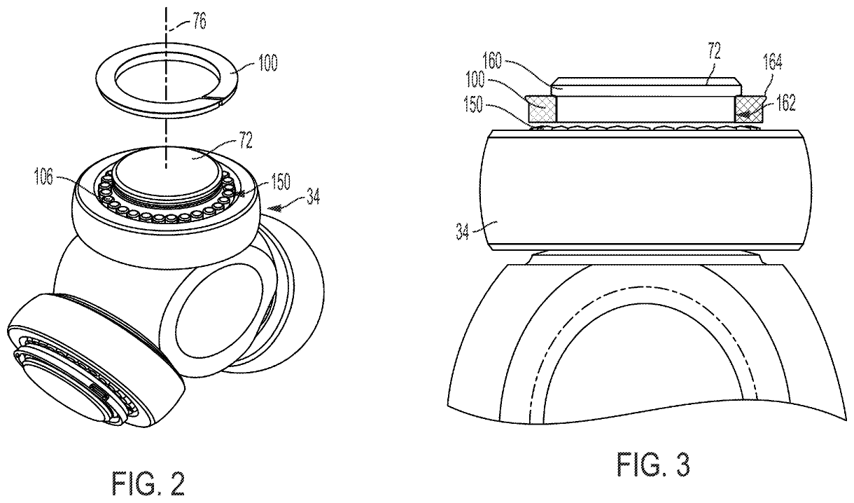

In one embodiment (FIGS. 2-5), a single retainer ring 100 is provided to both limit axial motion of a plurality of needle rollers 150 and keep the keep the ball set 34 attached to the trunnion 72. FIG. 2 shows the retainer ring 100 disassembled from the trunnion 72 and FIG. 3 illustrates the retainer ring 100 in an assembled condition with the trunnion 72.

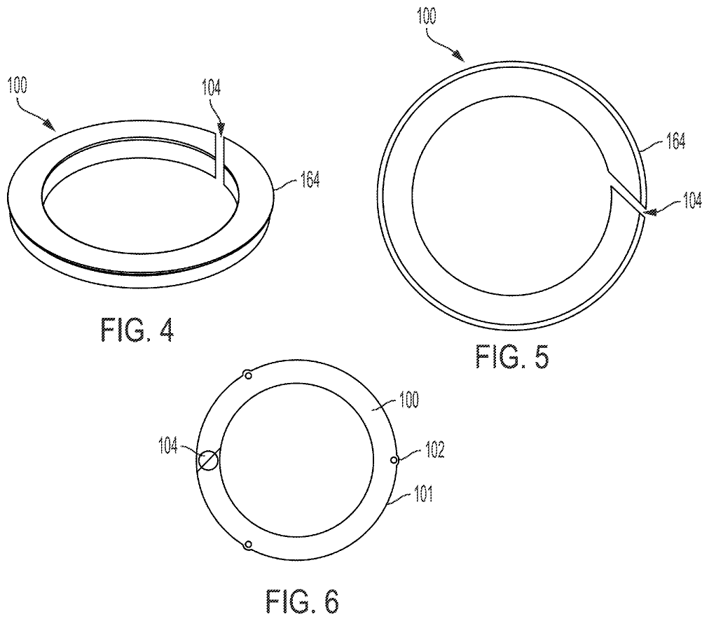

As shown in FIGS. 4 and 5, the retainer ring 100 has a cut 104, with respect to the outer diameter tangent, which allows expansion of the retainer ring for installation. This flexibility allows expansion of the retainer ring 100 to pass over a head portion 160 of the trunnion 72 until then retracting to securely fit within a groove 162 of the trunnion 72 that is at least partially defined by the head portion 160. The cut 104 also allows continuous movement of the needle rollers 150. In some embodiments, the cut 104 is about 45 degrees. The cut 104 is combined with flat ends 106 (FIG. 2) of the needle rollers 150. The flat ends 106 allow a continuous motion along the retainer ring 100 without experiencing a “discontinuity” when passing through the cut 104. In particular, the flat ends 106 prevent pulses or impulses due to ring discontinuity.

The retainer ring 100 is assembled to the trunnion 72 in any suitable manner, such as by a press fit operation, for example. The retainer ring 100 eliminates the need for a separate retainer. Upon installation of the retainer ring 100 to the trunnion 72, the axial retention feature 164—which may be a flange, tabs, or a similar protrusion—axially limits motion of a respective ball of the ball set 34.

FIG. 6 illustrates the retainer ring 100 with staked dimples 102. The staked dimples 102 facilitate retention of the ball members. In some embodiments, three staked dimples are provided and each is circumferentially spaced from one other at about 120 degrees around the outer diameter 101 of the retainer ring 100.

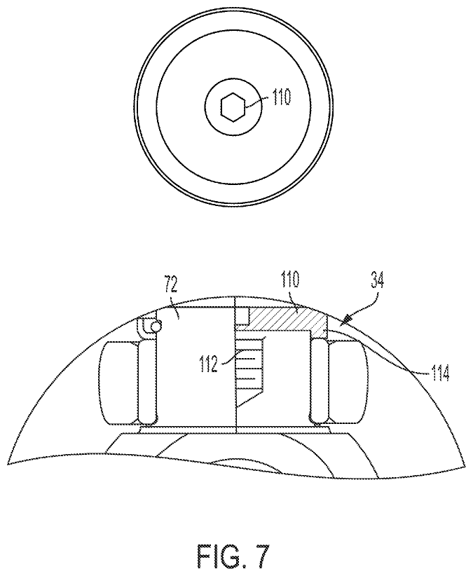

In another embodiment (FIG. 7), a cap 110 is bolted to the center of the trunnion 72. The cap 110 may be formed of alloyed steel in some embodiments. The thread 112 of the cap 110 can be selected or designed to endure cyclic loading. The area of the cap 110 that contacts the needle rollers has a tapered segment 114, similar to the tapered area at the base of the trunnion 72. This facilitates a rolling motion on the needle rollers. The cap 110 may feature staked dimples for ball retention or a lip that functions as a positive stop to retain the ball. The bolted cap 110 replaces a ring and retainer required in prior designs and eliminates the risk for fracture during loading conditions.

The embodiments described herein are simple and may reduce manufacturing costs, as no special operations (e.g., adding internal thread) are necessary on the trunnion in some embodiments.

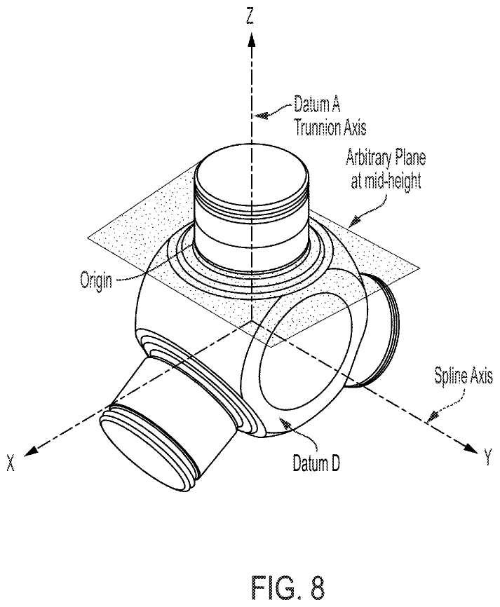

Referring now to FIGS. 8 and 9, a method of determining a parametric shape of the trunnion 72 is illustrated. While the above-described trunnions of the disclosed embodiments may be circular in cross-section to form substantially cylindrical trunnions, the disclosure also provides for alternative shapes. As discussed above, the needle rollers 150 have a reciprocating motion on the trunnion surface during joint operation. The amplitude of the needle displacement along the periphery of the trunnion is a function of joint angle and the load distribution among needles is a function of the applied torque. This combination of load and reciprocating displacement generates an intermittent stress field on the trunnion, which will eventually cause the contact surfaces to fail due to fatigue. This phenomena is known as spalling. Once spalling has initiated on a surface it will grow quickly changing friction properties and potentially inducing vibration in a driveline transmission system. A spider that is capable of operating for longer periods of time prior to spalling initiation or that is capable of operation at higher loads before spalling initiation would allow either a service life improvement or an overall mas reduction in a system. A way to achieve longer life or operation at higher loads is to distribute more uniformly the load among needles in contact in the trunnion or increase the number of needles carrying load, without increasing the trunnion diameter. Such load distribution can be achieved by altering the nominal shape of the trunnion, from cylindrical or circular, if looking at the transverse cross section of the trunnion, to elliptical, for example.

A design and manufacturing method that allows a seamless transition and flexibility in a mass production environment, from non-circular to circular trunnions and vice versa is disclosed herein and allows for making different trunnion profiles in the same piece of equipment with simple shape parameter changes. Such a design and manufacturing method that alters the trunnion shape based on a set of parametric equations in either Cartesian or polar format is provided herein. Such equations are linked to the Minimum Circumscribed Circle defining the trunnion diameter (FIG. 9).

Parametric equations in Cartesian format can be converted into a polar form and vice versa. The geometric shape defined by such equations is a function of the number of parameters and its relationship. For example, a circular shape requires only one parameter, which is the radius; an elliptical shape requires two parameters, which are the minor and major semi-axes. Complexity can be increased adding parameters. A shape with three or more parameters is defined as “parametric” in this document. Once a basic parametric equation has been established, its parameters can be tuned to change the load distribution characteristics on a trunnion, based on a given set of operating conditions, such as joint angle and transmitted torque. The parametric equation(s) can be programmed into the controller of a CNC grinder. Then changing trunnion shape becomes a matter of changing the parameters of the equation. A representative equation is as follows:

r(θ)=a₁+a₂ cos(2θ)+a₃ cos(4θ)+a₄ cos(6θ)+a₅ cos(8θ)+a₆ cos(10θ)+. . . +aₙ cos(2(n−1)θ)

where,
θ=Angular location (orientation)
r(θ)=Trunnion radial value
aᵢ=Parameter, for i=1, . . . , n

A 3-parameter flexible equation allows parameter 3 equal to zero and end up with an elliptical shape, or make parameters 2 and 3 equal to zero and end up with a circular shape.

The parametric equation may also be fitted with a phase shift ε which may be represented with the following:

r(θ−ε)=a₁+a₂ cos(2(θ−ε))+a₃ cos(4(θ−ε))+a₄ cos(6(θ−ε))+a₅ cos(8(θ−ε))+a₆ cos(10(θ−ε))+. . . +aₙ cos(2(n−1) (θ−ε))

Although the cosine trigonometric function is shown in the equations above, it is to be appreciated that the parametric equation may be written in terms of a sine function or some other trigonometric function.

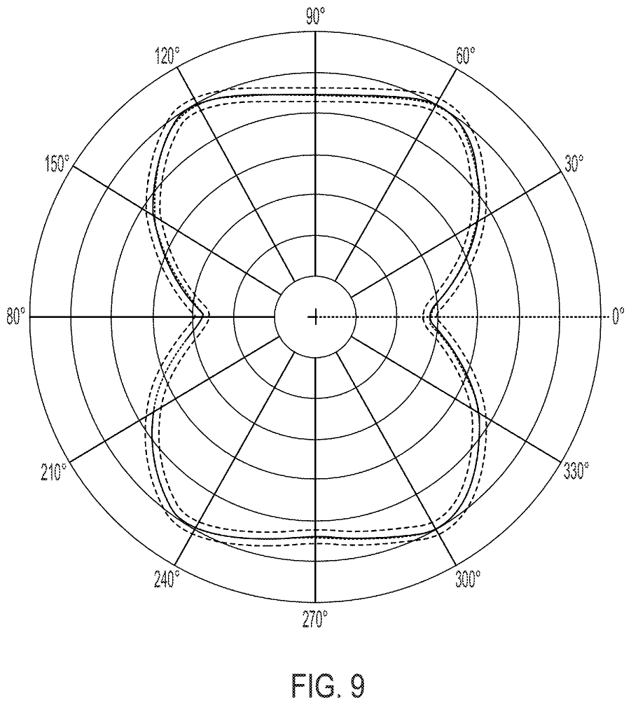

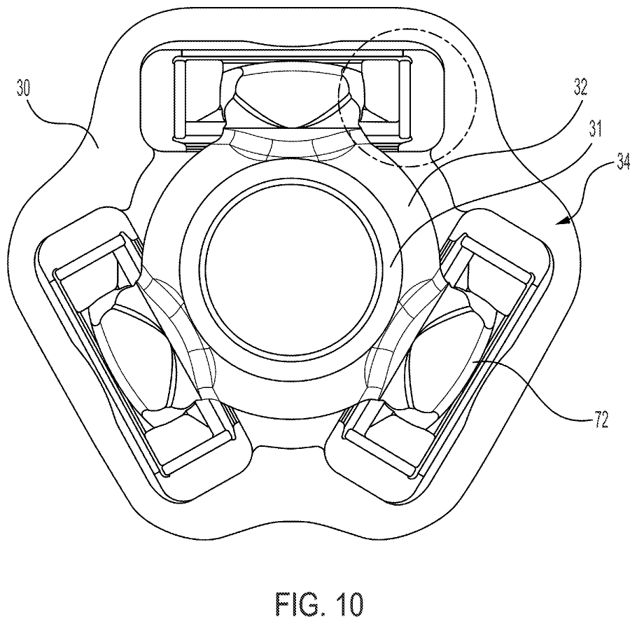

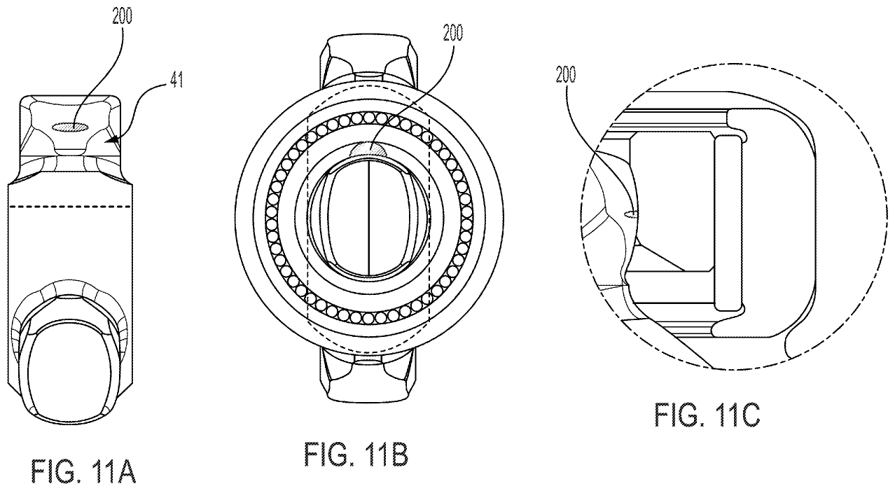

Referring now to FIGS. 10 and 11A-11C, additional embodiments of the disclosure are illustrated. The parametrically shaped trunnions are used for standard tripots, where the trunnion geometry can be made to a parametric shape to make the load distribution in contact areas more uniform. It is beneficial to reduce truncation of the contact patch between the trunnion and the inner ball 31, which reduces edge pressures that may break the lubricating film, potentially leading to grease starvation. FIGS. 10-11C shows the contact patch at low torques (e.g., 300 Nm in a 34 sz joint). FIGS. 10-11C illustrates the contact patch 41 on the trunnion surface (FIG. 11A); the pressure distribution 200 in the patch at the equator of the trunnion (also referred to herein as the “equatorial plane” (FIG. 11B); the pressure distribution 200 in the patch at a meridional direction (south to north on a cross section at the BCD plane) (FIG. 11C).

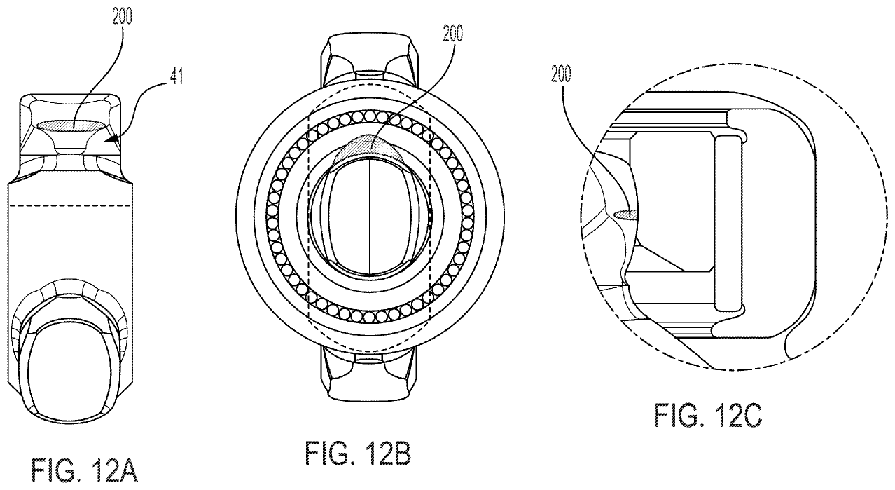

FIGS. 12A-12C show a contact patch where its area has increased, resultant from a higher torque. At this point the patch is at the limit of being fully contained. A subsequent increment in torque will cause the patch to “spill”.

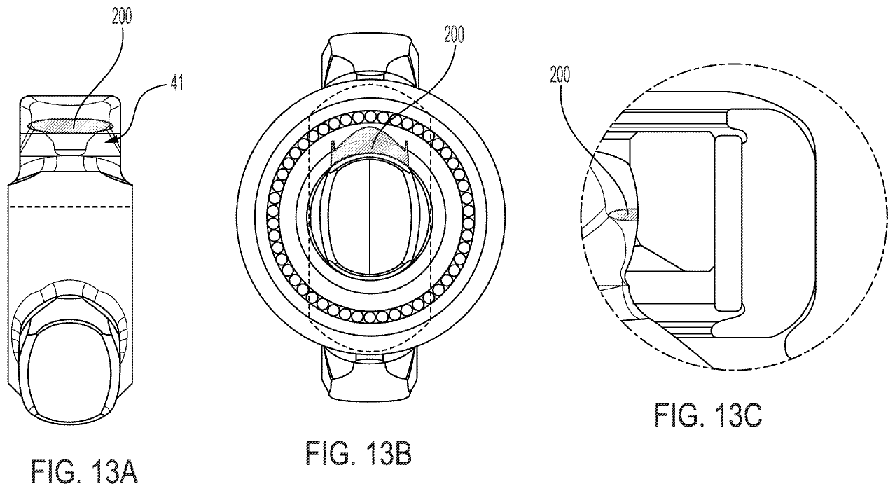

FIGS. 13A-13C show a contact patch that has started to “spill”. The truncation leads to edge contact which results in localized higher stresses. Spalling will tend to show up first at the center of the trunnion but might initiate on the edges too if the load is high enough for the edge stresses to be higher than the stress at the center of the trunnion. Truncation at mid-loads (e.g., 1000 Nm in a 34 sz joint) and higher may occur.

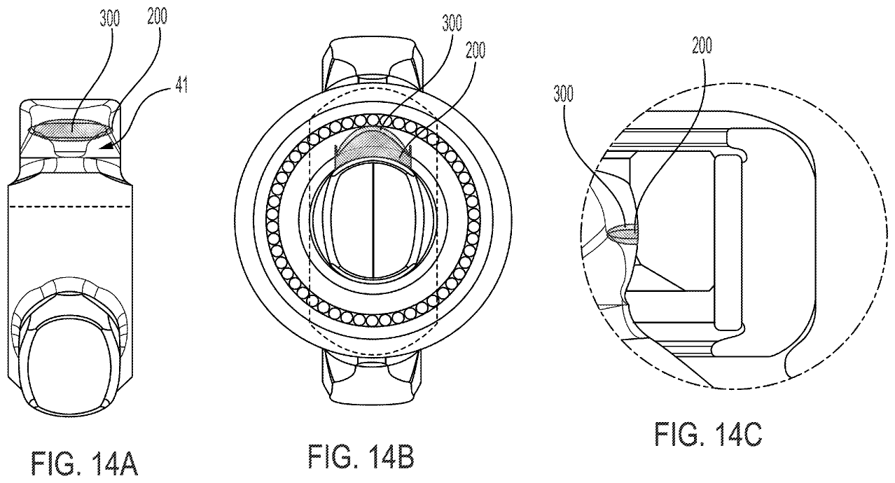

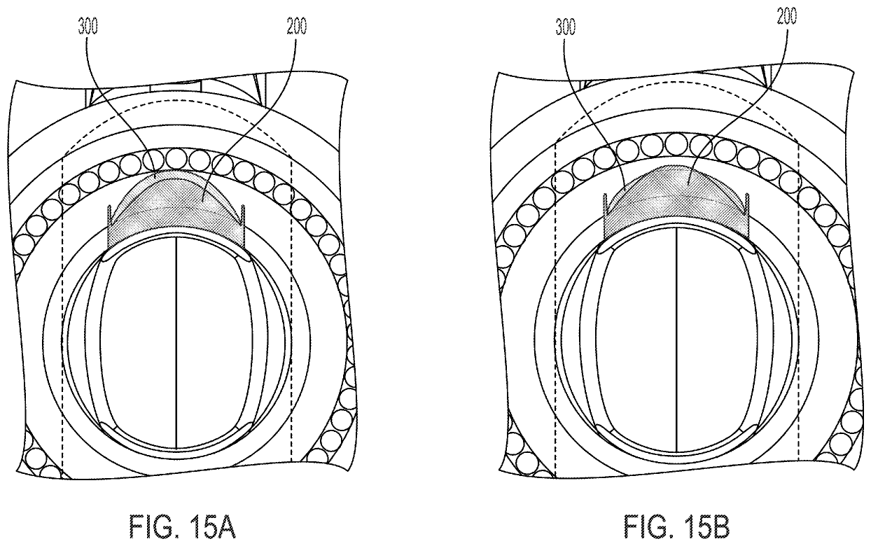

FIGS. 14A-14C show a contact patch that has been made wider in the meridional direction and shorter, on the equatorial direction, than the truncated patch—with the pressure distribution represented with 300. Such change in the shape of the patch can be achieved by changing the geometry of the trunnion, in the top view, from a circle to a parametric shape. The simplest parametric shape that can be used is an ellipse. However, the shape of the trunnion profile could be made based on a higher order curve (3^{rd} order or higher) to change the shape of the pressure distribution at the contact (e.g., more flat to reduce the peak stress value at the center), as shown in the comparison of FIGS. 15B vs. 15A. The design of a parametric shape is based on the instantaneous radius of curvature at the contact area. Eliminating patch truncation may improve lubrication at the contact area between the trunnion and the inner ball, more than reducing overall contact stresses.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A constant velocity joint comprising:
a trunnion extending radially outwardly about a trunnion axis, wherein the trunnion defines a parametric curve at an equatorial plane of the trunnion; and
a ball surrounding the trunnion and rotatable relative thereto about a plurality of needle rollers.

2. The constant velocity joint of claim 1, wherein the trunnion is one of three trunnions extending from a spider to form a tripot joint.

3. The constant velocity joint of claim 1, wherein the parametric curve of the trunnion is defined by at least two parameters.

4. The constant velocity joint of claim 3, wherein the trunnion has an elliptical shape defined by two parameters.

5. The constant velocity joint of claim 4, wherein the parameters of the parametric curve are selected to avoid truncation of the contact patch between the trunnion and the ball at a given design torque.

6. A method of determining a shape of a trunnion at an equatorial plane of the trunnion in a constant velocity joint comprising defining at least two parameters to be used in a parametric equation.

7. The method of claim 6, wherein the parametric equation is
r(θ)=a₁+a₂ cos(2θ)+a₃ cos(4θ)+a₄ cos(6θ)+a₅ cos(8θ)+a₆ cos(10θ)+. . . +aₙ cos(2(n−1)θ)
wherein θ=Angular location (orientation), r(θ)=Trunnion radial value, and aᵢ=Parameter, for i=1, . . . , n.

8. The method of claim 6, wherein the parametric equation is
r(θ−ε)=a₁+a₂ cos(2(θ−ε))+a₃ cos(4(θ−ε))+a₄ cos(6(θ−ε))+a₅ cos(8(θ−ε))+a₆ cos(10(θ−ε))+. . . +aₙ cos(2(n−1) (θ−ε))
wherein θ=Angular location (orientation), r(θ)=Trunnion radial value, and aᵢ=Parameter, for i=1, . . . , n.
